(19) United States
(12) Patent Application Publication
(10) Pub. No.: US 2026/0222670 A1
(43) Pub. Date: Jul. 30, 2026

(54) ELECTRONIC APPARATUS AND CONTROL METHOD OF THE ELECTRONIC APPARATUS

(71) Applicant: CANON KABUSHIKI KAISHA, Tokyo (JP)

(72) Inventors: NAOTO YONEDA, Tokyo (JP); HIROYUKI OWATARI, Tokyo (JP); TAKAHIRO SAMPEI, Tokyo (JP); TAKAHIRO KITSUNAI, Tokyo (JP); MARINA MIYAURA, Kanagawa (JP)

(21) Appl. No.: 19/577,849

(22) Filed: Mar. 25, 2026

Related U.S. Application Data
(63) Continuation of application No. PCT/JP2024/029065, filed on Aug. 15, 2024.

(30) Foreign Application Priority Data
Sep. 26, 2023 (JP) 2023-162921

(51) Int. Cl. H04N 23/611; G06V 40/18; H04N 23/63; H04N 23/667; H04N 23/67

(52) U.S. Cl. CPC H04N 23/611; G06V 40/18; H04N 23/633; H04N 23/667; H04N 23/67

(57) ABSTRACT

An electronic apparatus is the electronic apparatus for controlling display of a specific screen displayed on a display means according to the present disclosure includes a processor and a memory storing a program which, when executed by the processor, causes the moving-image file generation device to acquire a plurality of moving images respectively photographed during a plurality of continuous time blocks and a plurality of still images photographed during photographing of the plurality of moving images, and execute control processing that 1) chronologically displays the plurality of moving images in a first area of the specific screen and 2) displays, for each time block during which the one or more still images are photographed among the plurality of time blocks, a moving image photographed during the time block and the one or more still images photographed during the time block in association with each other in the first area.

### CROSS-REFERENCE TO RELATED APPLICATIONS

This application is a Continuation of International Patent Application No. PCT/JP2024/029065, filed August 15, 2024, which claims the benefit of Japanese Patent Application No. 2023-162921, filed September 26, 2023, both of which are hereby incorporated by reference herein in their entirety.

### BACKGROUND

### Field of the Technology

The present disclosure relates to an electronic apparatus and a method for controlling an electronic apparatus.

### DESCRIPTION OF THE RELATED ART

A digital camera, which is capable of photographing a still image while photographing a moving image without stopping the photographing of the moving image, is known. In news reporting or the like, for manpower saving, a single photographer oftentimes photographs a moving image and a still image (hereinafter, the moving image and the still image are collectively referred to as "photographing data"). Therefore, it is important that a still image can be photographed using a single camera while a moving image is being photographed.

When a news article or the like is generated using photographing data, a photographer transmits the photographing data to an editor via the Internet, and the editor sorts and edits the photographing data.

However, since the moving image and the still image are stored as separate files, a relationship therebetween may be difficult to recognize. Therefore, in Japanese Patent Laid-Open No. 2010-147861, a still image is displayed in association on a timeline during playback of a moving image to allow easy recognition of the relationship between the moving image and the still image.

In Japanese Patent Laid-Open No. 2010-147861, it is certainly easy to recognize relationships between one selected moving image and a plurality of still images. However, it is not possible to simultaneously recognize relationships between a plurality of moving images and a plurality of still images. In particular, in generating a news article or the like, a sorting operation is performed from among a plurality of moving images which are short in time and a plurality of still images and consequently, even by using a technology according to a first embodiment of Japanese Patent Laid-Open No. 2010-147861, it is difficult to perform the sorting operation.

### SUMMARY

The present disclosure provides a technology for reducing the load of an operation of sorting out an image from among a plurality of moving images and a plurality of still images.

One aspect of the present disclosure is an electronic apparatus for controlling display of a specific screen displayed on a display means, the electronic apparatus including a processor and a memory storing a program which, when executed by the processor, causes the moving-image file generation device to acquire a plurality of moving images respectively photographed during a plurality of continuous time blocks and a plurality of still images photographed during photographing of the plurality of moving images, and execute control processing that 1) chronologically displays the plurality of moving images in a first area of the specific screen and 2) displays, for each time block during which the one or more still images are photographed among the plurality of time blocks, a moving image photographed during the time block and the one or more still images photographed during the time block in association with each other in the first area.

One aspect of the present disclosure is a control method of an electronic apparatus for controlling display of a specific screen displayed on a display, the method including acquiring a plurality of moving images respectively photographed during a plurality of continuous time blocks and a plurality of still images photographed during photographing of the plurality of moving images, and performing control that 1) chronologically displays the plurality of moving images in a first area of the specific screen and 2) displays, for each time block during which the one or more still images are photographed among the plurality of time blocks, a moving image photographed during the time block and the one or more still images photographed during the time block in association with each other in the first area.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of a photographing/editing system according to a first embodiment.

FIG. 2A and FIG. 2B are external views of a camera according to the first embodiment.

FIG. 3 is a configuration diagram of the camera according to the first embodiment.

FIG. 4A and FIG. 4B are configuration diagrams of a server and a PC according to the first embodiment.

FIG. 5 is a diagram illustrating a screen of an editing application according to the first embodiment.

FIG. 6 is a diagram illustrating a screen of the editing application according to a second embodiment.

FIG. 7 is a flow chart of an operation of the camera according to the first embodiment.

FIG. 8 is a flow chart of an operation of the server according to the first embodiment.

FIG. 9 is a flow chart of an operation of the PC according to the first embodiment.

FIG. 10 is a flow chart of an operation of the camera according to the second embodiment.

FIG. 11 is a flow chart of an operation of the server according to the second embodiment.

FIG. 12 is a flow chart of an operation of the PC according to the second embodiment.

FIG. 13 is a flow chart of processing responding to a photographing signal or the like according to the second embodiment.

FIG. 14A to FIG. 14C are diagrams illustrating editing processing according to a third embodiment.

FIG. 15 is a flow chart of an operation of the PC according to the third embodiment.

### DESCRIPTION OF THE EMBODIMENTS

Hereinafter, embodiments of the present disclosure will be described in detail with reference to the drawings.

### First Embodiment

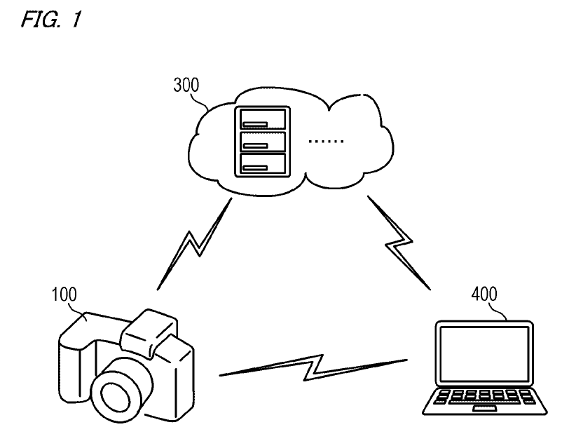

FIG. 1 is a schematic diagram illustrating an example of an overall configuration of a photographing/editing system according to the first embodiment. The photographing/editing system according to the first embodiment includes a camera 100, a server 300, and a personal computer (PC) 400. The server 300 and the PC 400 are information processing apparatuses (electronic apparatuses) that handle images captured by an image capturing device such as the camera 100. FIG. 1 illustrates a configuration in which the camera 100 and the PC 400 are connected wirelessly or by wire or the like to be communicative with each other.

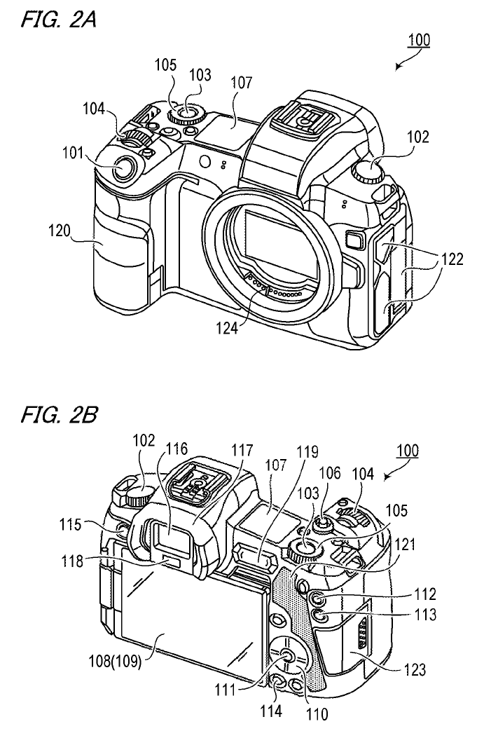

FIG. 2A and FIG. 2B are external views illustrating an example of the appearance of the camera 100 serving as the image capturing device. FIG. 2A is a perspective view of the camera 100 when viewed from a front side, and FIG. 2B is a perspective view of the camera 100 when viewed from a rear side.

The camera 100 includes, on an upper surface thereof, a shutter button 101, a power switch 102, a mode change-over switch 103, a main electronic dial 104, a sub-electronic dial 105, a moving image button 106, and an outside-finder display unit 107. The shutter button 101 is an operation member for giving a photographing preparation instruction or a photographing instruction. The power switch 102 is an operation member for switching the power of the camera 100 between ON and OFF states. The mode change-over switch 103 is an operation member for switching between various modes. The main electronic dial 104 is a rotary operation member for changing set values of a shutter speed, an aperture, and the like. The sub-electronic dial 105 is a rotary operation member for performing movement of a selection frame (cursor), image feeding, and the like. The moving image button 106 is an operation member for giving instructions to start and stop moving image photographing (recording). The outside-finder display unit 107 displays the various set values of the shutter speed, the aperture, and the like.

The camera 100 includes, on a rear surface thereof, a display unit 108, a touch panel 109, a direction key 110, a SET button 111, an AE lock button 112, an enlargement button 113, a playback button 114, a menu button 115, an eyepiece portion 116, an eye approach detection unit 118, and a touch bar 119. The display unit 108 displays images and various types of information. The touch panel 109 is an operation member for detecting a touch operation on a display surface (touch operation surface) of the display unit 108. The direction key 110 is an operation unit configured to include a key (four-direction key) which can be pressed upward, downward, leftward, and rightward. The camera 100 can execute processing depending on a pressed position on the direction key 110. The SET button 111 is an operation member to be pressed mostly when a selected item is to be determined. The AE lock button 112 is an operation member to be pressed when an exposure state is to be fixed in a photographing standby state. The enlargement button 113 is an operation member for switching an enlargement mode between the ON state and the OFF state in live view display (LV display) of a photographing mode. When the enlargement mode is ON, the main electronic dial 104 is operated to enlarge or reduce a live view image (LV image). In addition, the enlargement button 113 is used when a playback image is to be enlarged or a magnification ratio is to be increased in a playback mode. The playback button 114 is an operation member for switching between the photographing mode and the playback mode. In the case of the photographing mode, by pressing the playback button 114, the photographing mode shifts to the playback mode, and a latest image among the images recorded on a recording medium 227 described later can be displayed on the display unit 108.

The menu button 115 is an operation member to be pressed in order to display a menu screen that allows various settings to be made on the display unit 108. A user can intuitively make various settings by using the menu screen displayed on the display unit 108, the direction key 110, and the SET button 111. The eyepiece portion 116 is a segment in which a user brings his or her eye closer to the eyepiece finder (look-in type finder) 117, and looks into the eyepiece finder 117. The user can visually recognize a video displayed on an EVF 217 (Electronic View Finder), which will be described later, inside of the camera 100 via the eyepiece portion 116. The eye approach detection unit 118 is a sensor for detecting whether or not the user has brought his or her eye closer to the eyepiece portion 116 (eyepiece finder 117).

The touch bar 119 is a linear touch-operation member (line touch sensor) capable of receiving a touch operation. The touch bar 119 is arranged at a position where the user can perform a touch operation on (can touch) the touch bar 119 with his or her right thumb, while holding a grip portion 120 with his or her right hand (while holding the grip portion 120 with his or her right little finger, right ring finger, and right middle finger) so as to be able to press the shutter button 101 with his or her right index finger. In other words, the touch bar 119 is operable in a state where the user has brought his or her eye closer to the eyepiece finder 117 to look into the eyepiece portion 116, and is ready to press the shutter button 101 at any time (in a photographing attitude). The touch bar 119 can receive a tapping operation performed thereon (operation of touching and releasing the touch bar 119 within a predetermined period after the touching without moving a touched position), a lateral sliding operation (operation of touching the touch bar 119 and then moving the touched position while keeping the touch), and the like. The touch bar 119 is an operation member different from the touch panel 109, and does not have a display function. The touch bar 119 functions as, e.g., a multi-functional bar (M-Fn bar) to which various functions can be allocated.

The camera 100 further includes the grip portion 120, a thumb rest portion 121, a terminal cover 122, a lid 123, a communication terminal 124, and the like. The grip portion 120 is a held portion formed into a shape that is easy for the user to grip with his or her right hand when holding the camera 100. The shutter button 101 and the main electronic dial 104 are arranged at positions where the user can operate the shutter button 101 and the main electronic dial 104 with his or her right index finger, while holding the camera 100 by holding the grip portion 120 with his or her right little finger, right ring finger, and right middle finger. Meanwhile, in a similar state, the sub-electronic dial 105 and the touch bar 119 are arranged at positions where the user can operate the sub-electronic dial 105 and the touch bar 119 with his or her right thumb. The thumb rest portion 121 (thumb standby position) is a grip portion provided on a portion of the rear side of the camera 100 where the user can easily place his or her right thumb gripping the grip portion 120 without operating any of the operation members. The thumb rest portion 121 is made of a rubber member or the like for enhancing a holding force (grip feeling). The terminal cover 122 protects connectors such as connection cables for connecting the camera 100 to an external apparatus (external device). The lid 123 protects the recording medium 227 described later and a slot by closing a slot for storing the recording medium 227. The communication terminal 124 is a terminal for communicating with a lens unit (such as a lens unit 200 described later) side detachable from the camera 100.

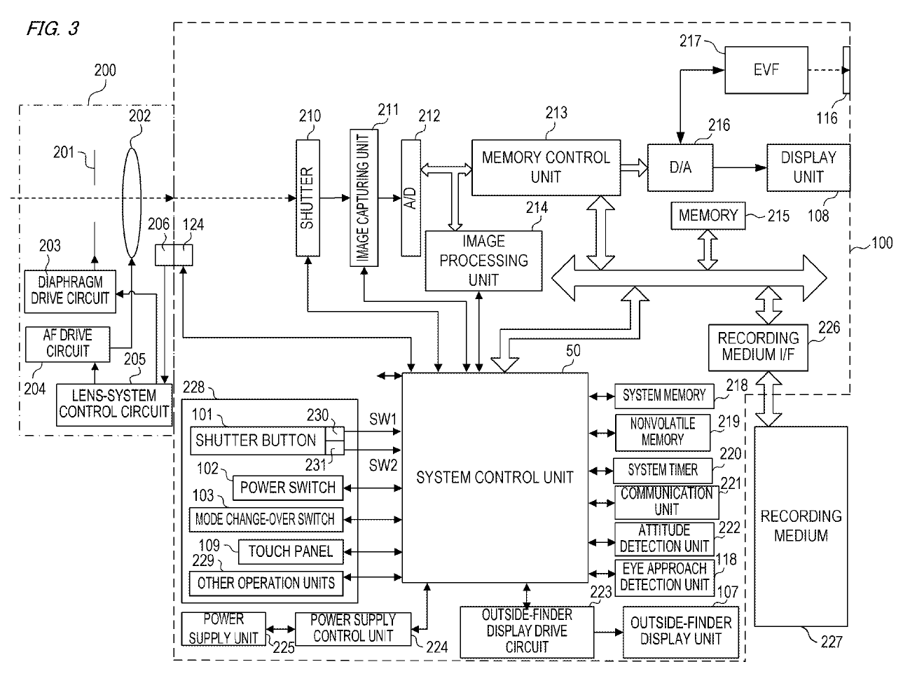

FIG. 3 is a block diagram illustrating an example of a configuration of the camera 100. Note that the same components as those in FIG. 2 are denoted by the same reference signs as those in FIG. 2, and a description of the components is omitted as appropriate. In FIG. 3, the lens unit 200 is attached to the camera 100.

First, a description will be given of the lens unit 200. The lens unit 200 is a type of interchangeable lens detachable from the camera 100. The lens unit 200 is a single-lens unit, and is an example of a typical lens. The lens unit 200 has a diaphragm 201, a lens 202, a diaphragm drive circuit 203, an AF (autofocus) drive circuit 204, a lens system control circuit 205, a communication terminal 206, and the like.

The diaphragm 201 is configured to have an adjustable aperture diameter. The lens 202 is configured to include a plurality of lenses. The diaphragm drive circuit 203 adjusts an amount of light by controlling the aperture diameter of the diaphragm 201. The AF drive circuit 204 drives the lens 202 to focus. The lens system control circuit 205 controls the diaphragm drive circuit 203, the AF drive circuit 204, and the like on the basis of instructions from a system control unit 50 described later. The lens system control circuit 205 controls the diaphragm 201 via the diaphragm drive circuit 203, and changes the position of the lens 202 via the AF drive circuit 204 to focus. The lens system control circuit 205 is capable of communication with the camera 100. Specifically, the communication is performed via the communication terminal 206 of the lens unit 200 and the communication terminal 124 of the camera 100. The communication terminal 206 is a terminal for the lens unit 200 to perform communication with the camera 100 side.

Next, a description will be given of the camera 100. The camera 100 has a shutter 210, an image capturing unit 211, an A/D converter 212, a memory control unit 213, an image processing unit 214, a memory 215, a D/A converter 216, the EVF 217, the display unit 108, and the system control unit 50.

The shutter 210 is a focal plane shutter capable of freely controlling an exposure time for the image capturing unit 211 on the basis of an instruction from the system control unit 50. The image capturing unit 211 is an image capturing element (image sensor) configured to include a CCD, a CMOS element, or the like that converts an optical image to an electric signal. The image capturing unit 211 may also have an imaging plane phase difference sensor that outputs defocus amount information to the system control unit 50. The A/D converter 212 converts an analog signal output from the image capturing unit 211 to a digital signal. The image processing unit 214 performs predetermined processing (such as pixel interpolation, resize processing such as reduction, or color conversion processing) on data from the A/D converter 212 or on data from the memory control unit 213. In addition, the image processing unit 214 performs predetermined arithmetic processing by using captured image data, and the system control unit 50 performs exposure control and distance control on the basis of an obtained arithmetic result. By this processing, TTL (through-the-lens) type AF processing, AE (automatic exposure) processing, EF (flash pre-emission) processing, and the like are performed. Furthermore, the image processing unit 214 performs predetermined arithmetic processing by using the captured image data, and the system control unit 50 performs TTL-type AWB (automatic white balance) processing on the basis of the obtained arithmetic result.

The image data from the A/D converter 212 is written to the memory 215 via the image processing unit 214 and the memory control unit 213. Alternatively, the image data from the A/D converter 212 is written to the memory 215 via the memory control unit 213 without passing through the image processing unit 214. The memory 215 stores the image data obtained by the image capturing unit 211 and converted to digital data by the A/D converter 212. The memory 215 stores the image data to be displayed on the display unit 108 or the EVF 217. The memory 215 has a sufficient storage capacity to store a predetermined number of still images or a predetermined period of moving image and audio. The memory 215 serves also as a memory (video memory) for image display.

The D/A converter 216 converts the image data for display stored in the memory 215 to an analog signal, and supplies the analog signal to the display unit 108 and the EVF 217. Accordingly, the image data for display written to the memory 215 is displayed on the display unit 108 or the EVF 217 via the D/A converter 216. The display unit 108 and the EVF 217 perform display according to the analog signal from the D/A converter 216. For example, each of the display unit 108 and the EVF 217 is a display such as LCD or organic EL. A digital signal subjected to A/D conversion by the A/D converter 212 and stored in the memory 215 is converted to the analog signal by the D/A converter 216. The analog signal resulting from the conversion is sequentially transferred to the display unit 108 and the EVF 217, and an image based on the analog signal is displayed on the display unit 108 and the EVF 217. Thus, live view display is performed.

The system control unit 50 is a control unit including at least one processor and/or at least one circuit. In other words, the system control unit 50 may also be a processor, a circuit, or a combination of the processor and the circuit. The system control unit 50 controls the entire camera 100. The system control unit 50 executes the program recorded in the non-volatile memory 219 to implement each processing in a flow chart described later. In addition, the system control unit 50 also performs display control by controlling the memory 215, the D/A converter 216, the display unit 108, the EVF 217, and the like.

Meanwhile, the camera 100 has a system memory 218, the non-volatile memory 219, a system timer 220, a communication unit 221, an attitude detection unit 222, and the eye approach detection unit 118.

As the system memory 218, e.g., a RAM is used. Into the system memory 218, a constant for the operation of the system control unit 50, a variable, a program read from the non-volatile memory 219, and the like are loaded. The non-volatile memory 219 is an electrically erasable/recordable memory. As the non-volatile memory 219, for example, an EEPROM is used. In the non-volatile memory 219, the constant for the operation of the system control unit 50, the program, and the like are recorded. The program mentioned herein refers to a program for executing the flow charts described later. The system timer 220 is a timekeeping unit that measures the time to be used for various controls and the time of an internal clock.

The communication unit 221 performs transmission and reception of a video signal and an audio signal with the external apparatus connected wirelessly or via a wired cable. The communication unit 221 can also be connected to a wireless LAN (Local Area Network) or the Internet. Furthermore, the communication unit 221 can also communicate with the external apparatus via the Bluetooth (registered trademark) or Bluetooth Low Energy. The communication unit 221 can transmit images (including live images) captured with the image capturing unit 211, file names of the images, a photographing information signal indicating photographing information such as a photographing date and time, and the images recorded on the recording medium 227. The communication unit 221 can receive images and various other information from the external apparatus.

The attitude detection unit 222 detects the attitude of the camera 100 in a gravity direction. On the basis of the detected attitude, the attitude detection unit 222 can determine whether or not the image photographed by the image capturing unit 211 is an image photographed in a state where the camera 100 was held in a horizontal orientation or photographed in a state where the camera 100 was held in a vertical direction. The system control unit 50 can add orientation information corresponding to the attitude detected by the attitude detection unit 222 to the image file of the image photographed by the image capturing unit 211, or can also rotate the image depending on the detected attitude. As the attitude detection unit 222, for example, an acceleration sensor, a gyro sensor, or the like can be used. It is also possible to detect the movement (such as pan, tilt, lifting, or standing-still) of the camera 100 by using the attitude detection unit 222.

The eye approach detection unit 118 is capable of detecting the approach of any object to the eyepiece portion 116 (eyepiece finder 117). As the eye approach detection unit 118, for example, an infrared proximity sensor can be used. When the object approaches the eyepiece portion 116, infrared light projected from a light projecting portion of the eye approach detection unit 118 is reflected by the object, and received by a light receiving portion of the infrared proximity sensor. On the basis of the amount of the received infrared light, the distance from the eyepiece portion 116 to the object can be determined. Thus, the eye approach detection unit 118 performs eye approach detection for detecting the proximity distance of the object with respect to the eyepiece portion 116.

The eye approach detection unit 118 is an eye approach detection sensor for detecting the approach (eye approach) and separation (eye separation) of an eye (object) with respect to the eyepiece portion 116. When an object approaching the eyepiece portion 116 within a predetermined distance is detected from the non-eye-approaching state (non-approaching state), the eye approach detection unit 118 detects the approach of the eye. Meanwhile, when the object the approach of which has been detected is apart from the eye-approaching state (approaching state) by a predetermined distance or longer, the eye approach detection unit 118 detects the separation of the eye. A threshold for detecting the eye approach and a threshold for detecting the eye separation may differ from each other by, e.g., providing hysteresis or the like. It is assumed that, after the detection of the eye approach, the eye approach state is maintained until the eye separation is detected. It is assumed that, after the detection of the eye separation, the non-eye-approach state is maintained until the eye approach is detected.

The system control unit 50 switches between the display (displayed state) and non-display (non-displayed state) of the display unit 108 and the EVF 217 on the basis of the state detected by the eye approach detection unit 118. Specifically, when the camera 100 is in at least a photographing standby state and the setting of display destination switching is automatic switching, during non-eye approach, the system control unit 50 turns ON the display by switching the display destination to the display unit 108, while bringing the EVF 217 into the non-displayed state. Meanwhile, during the eye approach, the system control unit 50 turns ON the display by switching the display destination to the EVF 217, while bringing the display unit 108 into the non-displayed state. Note that the eye approach detection unit 118 is not limited to the infrared proximity sensor. Any other sensor that is capable of detecting a state considered to be an eye-approaching state may also be used as the eye approach detection unit 118.

Furthermore, the camera 100 has the outside-finder display unit 107, an outside-finder display drive circuit 223, a power supply control unit 224, a power supply unit 225, a recording medium I/F 226, an operation unit 228, and the like.

The outside-finder display unit 107 is driven by the outside-finder display drive circuit 223 to display various set values for the camera 100, such as the shutter speed and the aperture. The power supply control unit 224 is configured to include a battery detection circuit, a DC-DC converter, a switching circuit (circuit for switching blocks to be energized), and the like. The power supply control unit 224 performs detection of whether or not a battery is attached, the type of the battery, a battery level, and the like. In addition, the power supply control unit 224 controls the DC-DC converter on the basis of the detection results and an instruction from the system control unit 50, and supplies a required voltage to each of the units including the recording medium 227 for a required period.

The power supply unit 225 is a primary battery (such as an alkaline battery or a lithium battery), a secondary battery (such as an NiCd battery, an NiMH battery, or an Li battery), an AC adapter, or the like. The recording medium I/F 226 is an interface (such as a memory card or a hard disk) with the recording medium 227. The recording medium 227 is a memory card for recording photographed images. The recording medium 227 is configured of a semiconductor memory, a magnetic disk, or the like. The recording medium 227 may be detachable from the camera 100, or may also be embedded in the camera 100.

The operation unit 228 is an input unit that receives operations (user operations) from the user. The operation unit 228 is used to input various instructions to the system control unit 50. The operation unit 228 includes the shutter button 101, the power switch 102, the mode change-over switch 103, the touch panel 109, other operation units 229, and the like. The other operation units 229 include the main electronic dial 104, the sub-electronic dial 105, the moving image button 106, the direction key 110, the SET button 111, the AE lock button 112, the enlargement button 113, the playback button 114, the menu button 115, the touch bar 119, and the like.

The shutter button 101 has a first shutter switch 230 and a second shutter switch 231. The first shutter switch 230 outputs a first shutter switch signal SW1 when the first shutter switch 230 is turned ON during the operation on the shutter button 101, i.e., in a so-called half-pressed state (photographing preparation instruction). The system control unit 50 starts photographing preparation processing (such as AF processing, AE processing, AWB processing, or EF processing) in response to the output of the first shutter switch signal SW1. The second shutter switch 231 outputs a second shutter switch signal SW2 when the second shutter switch 231 is turned ON by the completion of the operation on the shutter button 101, i.e., in a so-called full-pressed state (photographing instruction). In response to the output of the second shutter switch signal SW2, the system control unit 50 starts a series of photographing processing (processing from the reading out of the signal from the image capturing unit 211 to the generation of an image file including a photographed image and the writing of the image file onto the recording medium 227).

The mode change-over switch 103 switches the operation mode of the system control unit 50 to any of a still-image photographing mode, a moving-image photographing mode, the playback mode, and the like. The still-image photographing mode includes an automatic photographing mode, an automatic scene determination mode, a manual mode, an aperture priority mode (Av mode), a shutter-speed priority mode (Tv mode), a program AE mode (P mode), and the like. In addition, the still-image photographing mode includes various scene modes, custom modes, and the like that provide photographing settings corresponding to different photographing scenes. By using the mode change-over switch 103, the user can directly switch the operation mode to any of the photographing modes described above. Alternatively, after temporary switching to a photographing mode list screen by using the mode change-over switch 103, the user can selectively switch to any of the plurality of displayed modes by using the operation unit 228. Likewise, the moving-image photographing mode may also include a plurality of modes.

The touch panel 109 is a touch sensor that detects various touch operations on the display surface (operation surface of the touch panel 109) of the display unit 108. The touch panel 109 and the display unit 108 can be integrally configured. For example, the touch panel 109 is attached to the upper layer of the display surface of the display unit 108 such that a light transmittance does not interfere with the display by the display unit 108. By associating input coordinates on the touch panel 109 with display coordinates on the display surface of the display unit 108, it is possible to configure a GUI (graphical user interface) that gives the impression that the user could directly operate a screen displayed on the display unit 108. For the touch panel 109, any of various methods, such as a resistance film method, a capacitance method, a surface elastic wave method, an infrared method, an electromagnetic induction method, an image recognition method, and an optical sensor method, can be used. Depending on the method, there are a method that detects a touch on the basis of contact with the touch panel 109 and a method that detects a touch on the basis of approach of a finger or a pen to the touch panel 109, but either method may be used.

The system control unit 50 can detect the following operations on the touch panel 109 or states.

A new touch on the touch panel 109 by a finger or pen that has not been touching the touch panel 109, i.e., the start of a touch (hereinafter referred to as Touch-Down).

A state where the touch panel 109 is being touched by a finger or pen (hereinafter referred to as Touch-On).

A state where a finger or pen is moving, while touching the touch panel 109 (hereinafter referred to as Touch-Move).

Removal (release) of a finger or pen that has been touching the touch panel 109 from the touch panel 109, i.e., the end of the touch (hereinafter referred to as Touch-Up).

A state where nothing is touching the touch panel 109 (hereinafter referred to as Touch-Off).

When the Touch-Down is detected, the Touch-On is detected simultaneously. After the Touch-Down, the Touch-On is normally detected continuously unless the Touch-Up is detected. When the Touch-Move is detected also, the Touch-On is detected simultaneously. Even when the Touch-On is detected, the Touch-Move is not detected unless a touch position is moving. After the Touch-Up of all the touched fingers or pen is detected, the Touch-Off is detected.

These operations/states and coordinates of positions on the touch panel 109 touched by the finger or pen are reported to the system control unit 50 via an internal bus. The system control unit 50 determines what operation (touch operation) has been performed on the touch panel 109 on the basis of the reported information. As for the Touch-Move, the moving direction of the finger or pen which is moving on the touch panel 109 can also be determined for each vertical component and each horizontal component on the touch panel 109 on the basis of a change in positional coordinates. When the Touch-Move over a predetermined distance or longer is detected, it is determined that a slide operation has been performed.

An operation of quickly moving a finger by a certain distance while keeping the finger in touch with the touch panel 109 and then releasing the finger is referred to as a flick. In other words, the flick is an operation of quickly tracing the touch panel 109 with a finger in such a manner as to flip the touch panel 109 with a finger. When the Touch-Move over a predetermined distance or longer at a predetermined speed or higher was detected, and then the Touch-Up was detected, it is determined that the flick was performed (it can be determined that there was the flick subsequently to the sliding operation). In addition, a touch operation of simultaneously touching (multi-touching) a plurality of spots (for example, two points) and moving respective touched positions closer to each other is referred to as Pinch-In, while a touch operation of moving the respective touched positions away from each other is referred to as Pinch-Out. Such Pinch-In and Pinch-Out are collectively referred to as a pinch operation (or simply a pinch).

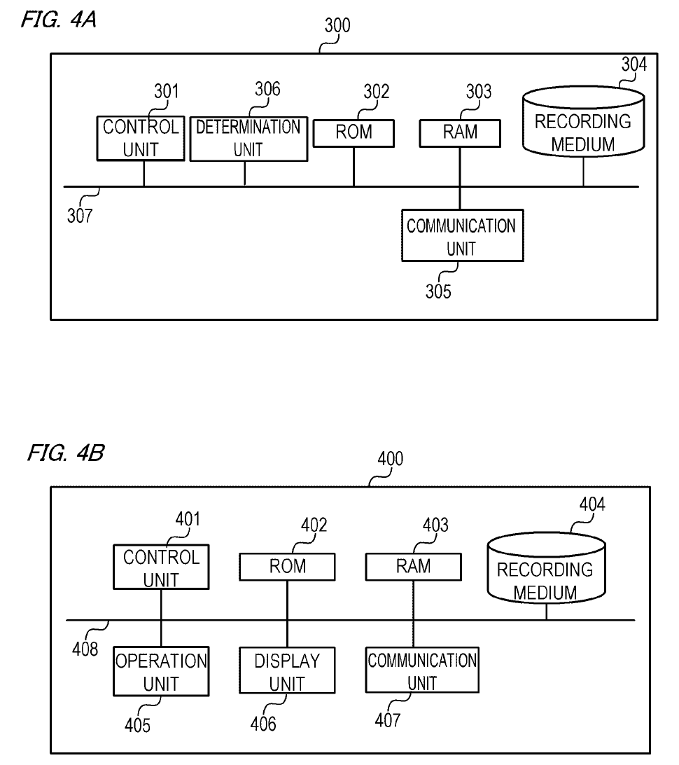

FIG. 4A is a block diagram illustrating an example of a configuration of a server 300, which is an apparatus external to the PC 400. The server 300 includes a control unit 301, a ROM 302, a RAM 303, a recording medium 304, a communication unit 305, and a determination unit 306. These components can be connected with each other via a system bus 307. Note that each of the components of the server 300 may also be included in the camera 100.

The control unit 301 is, e.g., a Central Processing Unit (CPU). The control unit 301 controls the entire server 300.

The ROM 302 is a Read Only Memory that non-temporarily stores programs and parameters.

The RAM 303 is a Random Access Memory for temporarily storing programs and data supplied from the external apparatus or the like.

The recording medium 304 is a medium (hard disk or flash memory) fixedly arranged in the server 300. Alternatively, the recording medium 304 is a medium (such as an optical disk, a magnetic card, an optical card, an IC card, or a memory card) detachable from the server 300.

The communication unit 305 communicates with external apparatuses (such as the camera 100 and the PC 400). The communication unit 305 receives a moving image and a still image from the camera 100. The received moving image and still image are stored on the recording medium 304. The communication unit 305 transmits, in response to a request from the PC 400, information on the images (moving and still images) stored on the recording medium 304 and a result of determining the state of the still image (such as whether or not the still image is in focus or has closed eyes) to the PC 400. At this time, the communication unit 305 may also transmit a determination signal indicating information on the determination result and information on the file name of the still image to the PC 400 separately from the still image. In addition, the communication unit 305 receives a photographing information signal indicating the photographing information of the still image generated by the camera 100, and transmits the photographing information signal to the PC 400.

The determination unit 306 determines the state of the still image (such as whether or not the still image is in focus or has closed eyes) stored on the recording medium 304. The determination unit 306 also stores the information on a result of determining the state of the still image, together with the still image, on the recording medium 304.

The system bus 307 communicatively connects the individual components of the server 300 to each other.

FIG. 4B is a block diagram illustrating an example of a configuration of the PC 400, which is an electronic apparatus. The PC 400 includes a control unit 401, a ROM 402, a RAM 403, a recording medium 404, an operation unit 405, a display unit 406, and a communication unit 407. These components are communicative with each other via a system bus 408.

The control unit 401 is, for example, a Central Processing Unit (CPU). The control unit 401 controls the entire PC 400. In addition, the control unit 401 communicates with the server 300 via the communication unit 407 to confirm whether or not a new moving image or still image has been transmitted from the camera 100 to the server 300. When the new moving image or still image has been transmitted to the server 300, the control unit 401 requests the server 300 to transmit the moving image or still image via the communication unit 407. Then, the control unit 401 stores the new moving image or still image on the recording medium 404. The control unit 401 automatically selects a moving image (moving image photographed during the same time block as that of the still image) corresponding to the still image selected in response to the operation on the operation unit 405.

The ROM 402 is a Read Only Memory which non-temporarily stores programs and parameters.

The RAM 403 is a Random Access Memory for temporarily storing programs and data supplied from external apparatuses or the like.

The recording medium 404 is a medium (such as a hard disk or a flash memory) fixedly arranged in the PC 400. Alternatively, the recording medium 404 is a medium (such as an optical disk, a magnetic card, an optical card, an IC card, or a memory card) that is detachable from the PC 400.

The operation unit 405 receives an operation by the user (editor) on the PC 400. For example, from among one or more still images satisfying the predetermined condition, any one is selected in response to the operation by the user on the operation unit 405. Here, the operation unit 405 may be an operation member (such as a button or a touch panel) provided in the PC 400, or may also be an operation member (such as a keyboard or mouse) that is detachable from the PC 400.

The display unit 406 displays data held by the PC 400, data supplied from an external device, or the like. In addition, the display unit 406 displays a list of the moving and still images recorded on the recording medium 404 on the same time axis. The display unit 406 can also display only the still images satisfying the predetermined condition. The display unit 406 can also display the moving image photographed during the same time block as that during which the still image selected by the operation unit 405 was photographed in respective predetermined areas of a specific screen. Furthermore, when the reception of the still image has been delayed, the display unit 406 displays the reception status of the still image and the determination result in accordance with the photographing information signal and the determination signal. Note that the display unit 406 may be included in the PC 400, or may also be a display device separate from the PC 400.

The communication unit 407 performs communication with external apparatuses such as the camera 100 and the server 300. The system bus 408 communicatively connects the individual components of the PC 400.

A description will be given below of basic processing from photographing to editing in the photographing and editing system. The photographing editing system includes the camera 100, the server 300, and the PC 400.

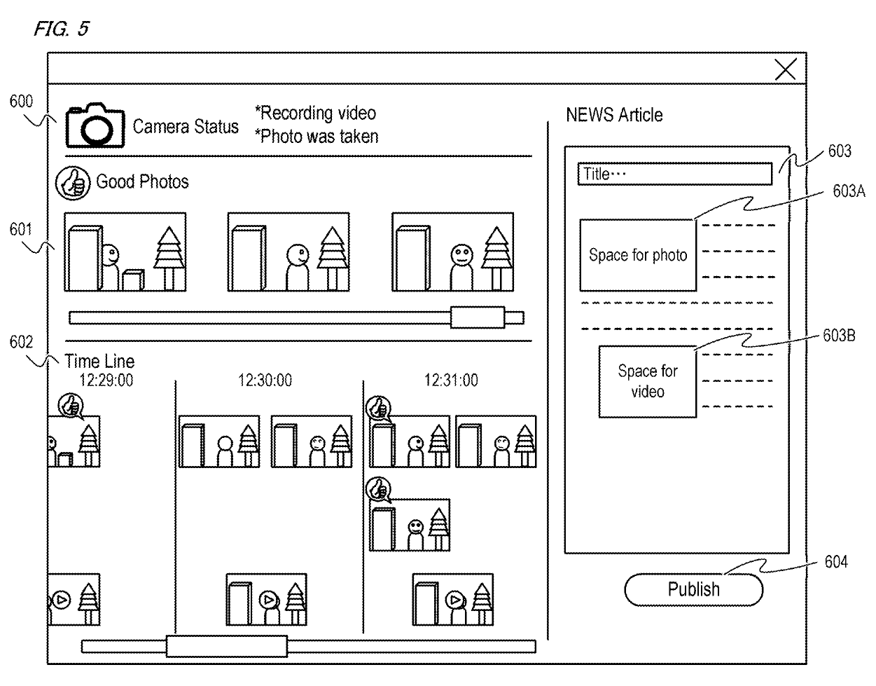

FIG. 5 illustrates an example of display of a screen (screen displayed on the display unit 406) of an editing application that operates on the PC 400. In the editing application, the PC 400 displays the moving images and still images received from the camera 100, and selects the still image and moving image (which are related to each other) to be used in a news article. In addition, according to the editing application, the PC 400 can edit a text (wording) in the news article, and publish a news article (public article) including the text in the news article together with the selected still image and moving image.

The screen of the editing application includes a status area 600, a Good area 601, a timeline area 602 and an article area 603. In the status area 600, a photographing status (status indicating whether or not the camera 100 is photographing a moving image and whether or not photographing of a still image has been executed) is displayed.

The Good area 601 displays one or more still images satisfying the predetermined condition that are arranged in the chronological order of photographing in the middle portion on the left side of the screen of the editing application. In addition, the user can select any of the one or more still images displayed in the Good area 601.

In the timeline area 602, the moving image and still images in each of photographing time blocks are displayed (in chronological order) on the timeline. In the timeline area 602, a plurality of moving images displayed are a plurality of moving images photographed in the consecutive time blocks. Each of the time blocks is a time range of a given length (e.g., 1 minute). Here, when a still image satisfies the predetermined condition (condition such as the composition, the in-focus state of a main subject, or presence or absence of the closed eyes), a Good icon (display item indicating an appropriately photographed still image is displayed so that the Good icon superimposed on a portion of the still image. Note that, when the still image does not satisfy the predetermined condition, a Bad icon (display item indicating a still image not appropriately photographed) may also be displayed so that the Bad icon is superimposed on a portion of the still image. On the still image, an icon corresponding to the state of the still image may also be superimposed (displayed). For example, it may also be possible that, on a still image in which a specific object is closing his or her eyes, an icon indicating the closed eyes is superimposed and, on a still image photographed in a specific composition, an icon indicating photographing in the specified composition is superimposed.

The article area 603 is an area for editing a news article. In the article area 603, the user can edit the title of the news article and the text in the article. The article area 603 includes a still image area 603A into which a still image is to be inserted (placed), and a moving image area 603B into which a moving image is to be inserted (placed). When a still image displayed in the Good area 601 is selected by a user operation such as a mouse click, the selected still image is inserted into the still image area 603A of the article area 603. In addition, the moving image photographed during the same time block as that of the still image is inserted into the moving image area 603B of the article area 603. As a result, it is possible to implement a preview close to the complete state of the news article.

As a result of the preview, when determining that the publication is possible, the user presses a publish button 604. Then, a final confirmation message asking whether or not the news article may be published is displayed. When it is determined from a response from the user to the final confirmation message that the user has given an instruction to publish the news article, the news article is distributed (published on the Internet).

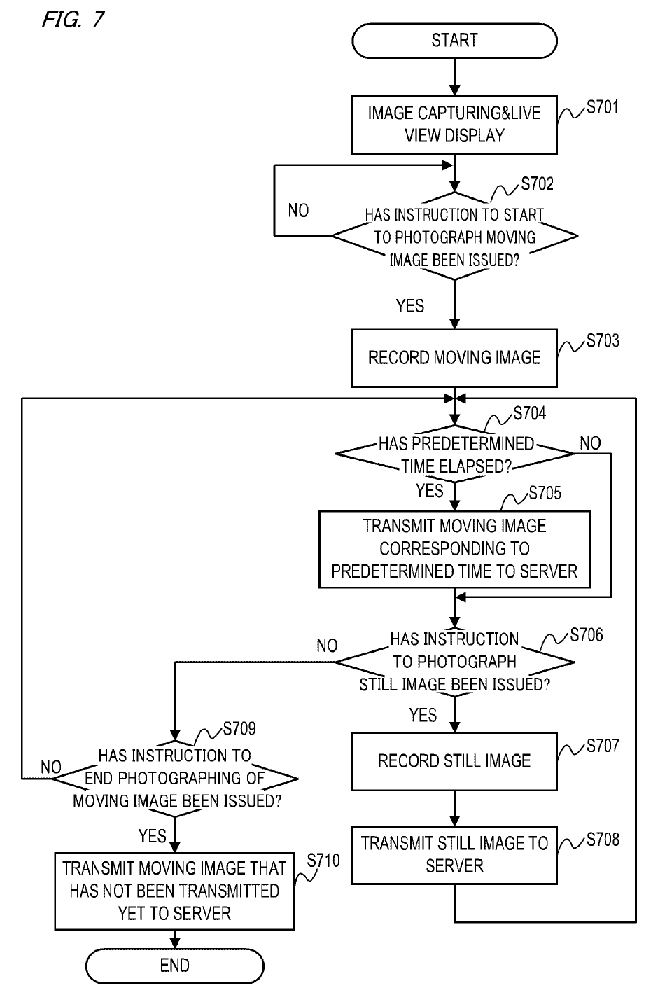

Referring to the flow chart of FIG. 7, a description will be given of the operation of the camera 100 according to the first embodiment. The flow chart of FIG. 7 is started when the camera 100 shifts to a photographing preparation state after the power of the camera 100 is turned ON (activated).

In Step S701, the system control unit 50 starts to capture images, and simultaneously starts live view display (display of a captured live view image).

In Step S702, the system control unit 50 determines whether or not an instruction to start to photograph a moving image (such as an operation on the moving image button 106 by a photographer) has been issued. When it is determined that the instruction to start to photograph a moving image has been issued, the flow proceeds to Step S703. When it is determined that the instruction to start to photograph a moving image has not been issued, the processing in S702 is repeated.

In Step S703, the system control unit 50 starts to photograph a moving image by using the image capturing unit 211, while starting to record the photographed moving image on the recording medium 227.

In Step S704, the system control unit 50 determines whether or not a predetermined time has elapsed since the processing in Step S705 was previously performed. When it is determined that the predetermined time has elapsed since the processing in Step S705 was previously performed, the flow proceeds to Step S705. When it is determined that the predetermined time has not elapsed since the processing in Step S705 was previously performed, the flow proceeds to Step S706. The predetermined time is a relatively short time (any time between 15 seconds and 3 minutes or the like) set in advance by the photographer in consideration of, e.g., the performance of the camera 100, a communication environment during transmission the moving image, and the like.

In Step S705, the system control unit 50 transmits, to the server 300, a moving image corresponding to a predetermined time since the processing in Step S705 was previously performed. The processing of transmitting the moving image corresponding to the predetermined time period to the server 300 continues until an instruction to end photographing of the video image is issued.

In Step S706, the system control unit 50 determines whether or not an instruction to photograph a still image has been issued. When it is determined that the instruction to photograph a still image has been issued, the flow proceeds to Step S707. When it is determined that the instruction to photograph a still image has not been issued, the flow moves to Step S709.

In Step S707, the system control unit 50 photographs one still image, and records the one still image on the recording medium 227.

In Step S708, the system control unit 50 transmits the still image photographed in Step S707 to the server 300. Note that, when the instruction to photograph a still image is issued in Step S706, in Steps S707 and S708, the system control unit 50 may also continuously photograph a plurality of still images until an instruction to end the photographing of the still images is issued, and transmit the plurality of photographed still images to the server 300.

In Step S709, the system control unit 50 determines whether or not the instruction to end the photographing of a moving image has been issued. When it is determined that the instruction to end the photographing of the moving image has been issued, the flow proceeds to Step S710. When it is determined that the instruction to end the photographing of the moving image has not been issued, the flow proceeds to Step S704.

In Step S710, the system control unit 50 ends the photographing of the moving image. Then, the system control unit 50 transmits, to the server 300, the moving image corresponding to a remaining time that has not been transmitted yet to the server 300 (moving image that has not been transmitted in Step S705).

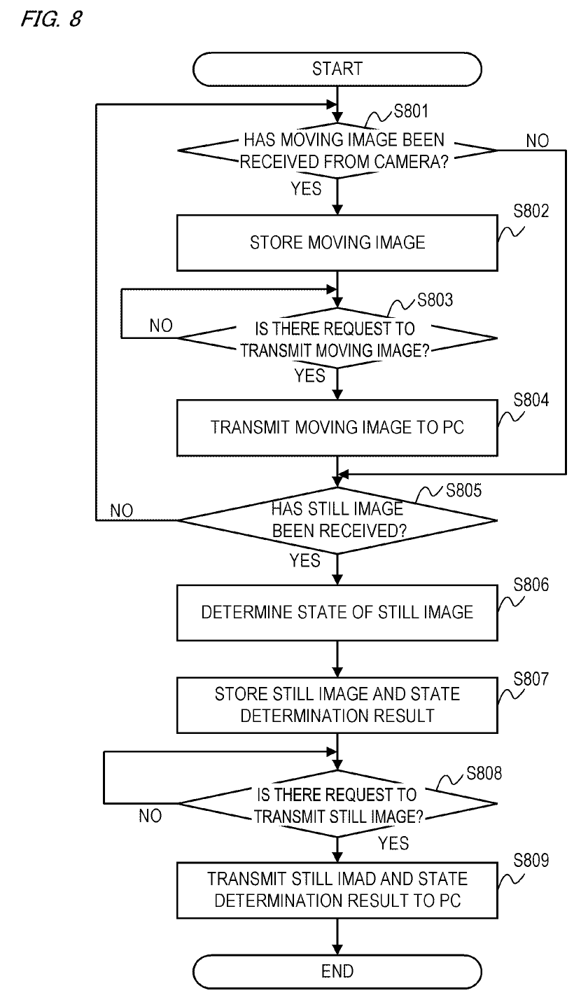

Referring to the flow chart of FIG. 8, a description will be given of the operation of the server 300 according to the first embodiment. The processing in the flow chart of FIG. 8 may be executed continuously and repeatedly, or may also be executed every time any information is transmitted from the camera 100 to the server 300.

In Step S801, the control unit 301 determines whether or not a moving image has been received from the camera 100. When it is determined that a moving image has been received from the camera 100, the flow proceeds to Step S802. When it is determined that a moving image has not been received from the camera 100, the flow proceeds to Step S805.

In Step S802, the control unit 301 stores, in the database of the recording medium 304, the moving image received in Step S801.

In Step S803, the control unit 301 determines whether or not there is a request to transmit a moving image from the PC 400 (an instruction to request the server 300 to transmit a moving image to the PC 400 has been issued). When it is determined that the transmission of a moving image has been requested, the flow proceeds to Step S804. When it is determined that the transmission of a moving image has not been requested, the processing in Step S803 is repeated.

In Step S804, the control unit 301 transmits, to the PC 400, the moving image that has not been transmitted yet to the PC 400. Here, with respect to the moving images already transmitted to the PC 400, the control unit 301 stores, in the database, the moving images in association with information indicating an already transmitted status. This can prevent the control unit 301 from transmitting the same moving image to the PC 400 a plurality of times.

In Step S805, the control unit 301 determines whether or not a still image has been received from the camera 100. When it is determined that a still image has been received from the camera 100, the flow proceeds to Step S806. When it is determined that a still image has not been received from the camera 100, the flow proceeds to Step S801.

In Step S806, the control unit 301 controls the determination unit 306 to determine a state of the still image (such as the composition in the still image, the in-focus state of the main subject, or the presence or absence of an eye-closed state). The control unit 301 can use a predetermined algorithm, a predetermined AI (Artificial Intelligence), or the like to determine the state of the still image.

In Step S807, the control unit 301 associates a result of determining the state of the still image (such as the composition, the in-focus state of the main subject, or the presence or absence of the eye-closed state) (hereinafter referred to as the "state determination result" with the still image, and stores the state determination result and the still image in the database of the recording medium 304.

In Step S808, the control unit 301 determines whether or not there is a request to transmit a still image from the PC 400 (the instruction to request the server 300 to transmit a still image to the PC 400 has been issued). When it is determined that the request to transmit a still image has been issued from the PC 400, the flow proceeds to Step S809. When it is determined that the request to transmit a still image has not been issued from the PC 400, the processing in Step S808 is repeated.

In Step S809, the control unit 301 transmits, to the PC 400, the still image that has not been transmitted yet to the PC 400 together with the state determination result (information on the state determination result) of the still image. Here, with respect to the still images that have been transmitted to the PC 400, the control unit 301 stores, in the database, the information indicating the already transmitted status in association with the still images. This can prevent the control unit 301 from transmitting the same still image to the PC 400 a plurality of times.

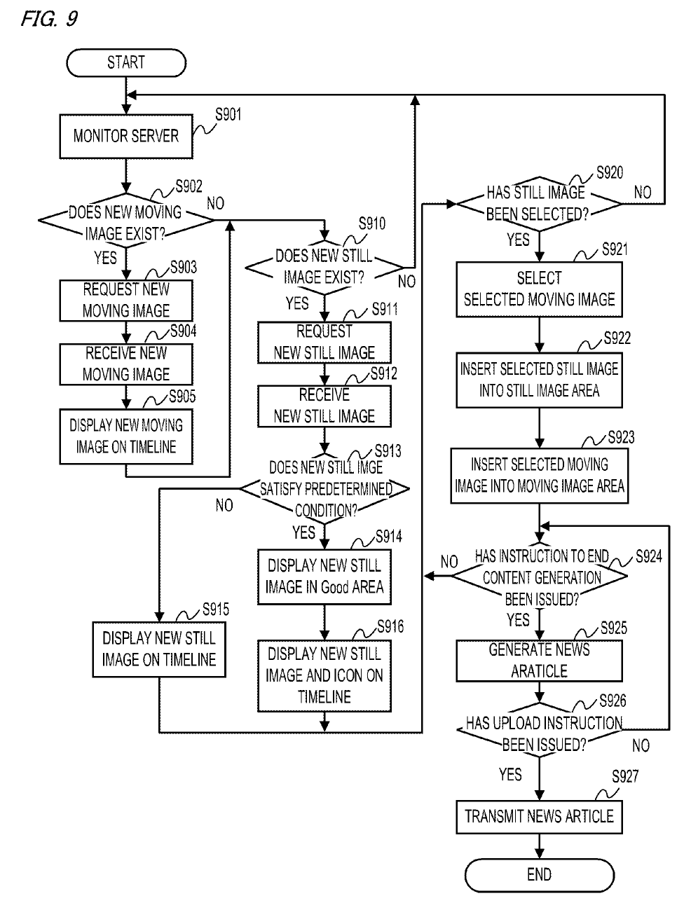

Referring to the flow chart of FIG. 9, a description will be given of the operation of the PC 400 according to the first embodiment. The processing in the flow chart of FIG. 9 is started when the PC 400 is activated.

In Step S901, the control unit 401 starts to monitor the database of the server 300 (database of the recording medium 304).

In Step S902, the control unit 401 determines whether or not a new moving image (moving image that has not been transmitted to the PC 400) exists in the database of the server 300. When it is determined that a new moving image (hereinafter referred to as the "new moving image") exists in the database, the flow proceeds to Step S903. When it is determined that no new moving image exists in the database, the flow proceeds to Step S910.

In Step S903, the control unit 401 requests the server 300 to transmit a new moving image.

In Step S904, the control unit 401 receives the new moving image from the server 300.

In Step S905, the control unit 401 acquires, on the basis of the received new moving image, a thumbnail of the new moving image. Then, the control unit 401 displays (adds) the thumbnail of the new moving image in (to) an area of the timeline area 602 shown in FIG. 5 that corresponds to the time block during which the new moving image was photographed.

In Step S910, the control unit 401 determines whether or not a new still image (still image that has not been transmitted to the PC 400) exists in the database of the server 300. When it is determined that a new still image (hereinafter referred to as the "new still image") exists in the database, the flow proceeds to Step S911. When it is determined that no new still image exists in the database, the flow proceeds to Step S901.

In Step S911, the control unit 401 requests the server 300 to transmit the new still image.

In Step S912, the control unit 401 receives the new still image and the state determination result of the new still image from the server 300.

In Step S913, the control unit 401 determines whether or not the new still image satisfies the predetermined condition on the basis of the received state determination result. Here, the predetermined condition is a condition for determining whether or not an appropriate still image has been photographed. Specifically, the predetermined condition is a condition that photographing is performed in a specific composition, a condition that a specific subject does not close his or her eyes, a condition that the specific subject is in focus, or the like. Alternatively, the predetermined condition may also be a condition that the photographing is not performed using back light, a condition that the line of sight of a person in the still image is not directed toward the camera 100, a condition that a plurality of persons are in the still image, or the like. When it is determined that the new still image satisfies the predetermined condition, the flow proceeds to Step S914. When it is determined that the new still image does not satisfy the predetermined condition, the flow proceeds to Step S915.

In Step S914, the control unit 401 displays (adds) a new still image in (to) the Good area 601 shown in FIG. 5.

In Step S915, the control unit 401 displays (adds) a new still image in (to) an area of the timeline area 602 shown in FIG. 5 that corresponds to the time block during which the new still image was photographed.

In Step S916, the control unit 401 displays (adds) the new still image, together with the Good icon, in (to) the area of the timeline area 602 shown in FIG. 5 that corresponds to the time zone during which the new still image was photographed.

By the processing in Steps S915 and S916, the new moving image and the new still image that were photographed during the same time block are associated with each other and displayed in the timeline area 602.

In Step S920, the control unit 401 determines whether or not one still image in the Good area 601 has been selected by a user operation. Note that control unit 401 may also determine whether or not one still image has been selected from either one of the Good area 601 and the timeline area 602. When it is determined that one still image has been selected, the flow proceeds to Step S921. When it is determined that one still image has not been selected, the flow proceeds to Step S901.

In Step S921, the control unit 401 selects a moving image (hereinafter referred to as the "selected moving image") photographed during the same time block as that of the still image selected in Step S920 (hereinafter referred to as the "selected still image").

In Step S922, the control unit 401 inserts (places) the selected still image into the still image area 603A shown in FIG. 5.

In Step S923, the control unit 401 inserts (places) the selected moving image into the moving image area 603B. At this time, the user (editor) can preview (confirm) the entire news article (news article content), as shown in the article area 603 of FIG. 5.

In Step S924, the control unit 401 determines whether or not an instruction to end the generation of the content of the news article has been issued by pressing the publish button 604 shown in FIG. 5. When it is determined that the instruction to end the content generation has been issued, the flow proceeds to Step S925. When it is determined that the instruction to end the content generation has not been issued, the flow proceeds to Step S920. Note that, until the publish button 604 is pressed, the form (such as position or size) of the selected still image or the form of the selected moving image in the news article may also be adjustable by a user operation. Alternatively, the text in the article may also be changeable by a user operation.

In Step S925, the control unit 401 generates a news article (news article content) containing the selected still image, the selected moving image, and the text in the article.

In Step S926, the control unit 401 determines whether or not an instruction to upload the news article (news article content) has been issued after the final confirmation message before publication was confirmed by the user. When it is determined that the upload instruction has been issued, the flow proceeds to Step S927. When it is determined that the upload instruction has not been issued, the flow proceeds to Step S924.

In Step S927, the control unit 401 transmits the news article to a distribution server. As a result, the distribution server publishes the news article on the Internet.

According to the first embodiment, by viewing the timeline area, the user can recognize the moving image and still images that were photographed during the same time block. In addition, since the Good icon is attached to the still image that satisfies the predetermined condition, the user can select a more preferable still image. Moreover, when one still image is selected, the moving image photographed during the same time block as that of the still image is selected. Therefore, the user can more easily select the still images and moving image that were photographed during the same time block. When one still image is selected, the still images and moving image that were photographed during the same time block are inserted into a news article content, which facilitates the production of the news article by the user.

### Second Embodiment

In the second embodiment, the PC 400 displays a reception status of the still image and a reception status of the state determination result according to the signal received from the server 300. Note that, hereinafter, a description of components and processing that are the same as in the second embodiment and the first embodiment will be omitted as appropriate.

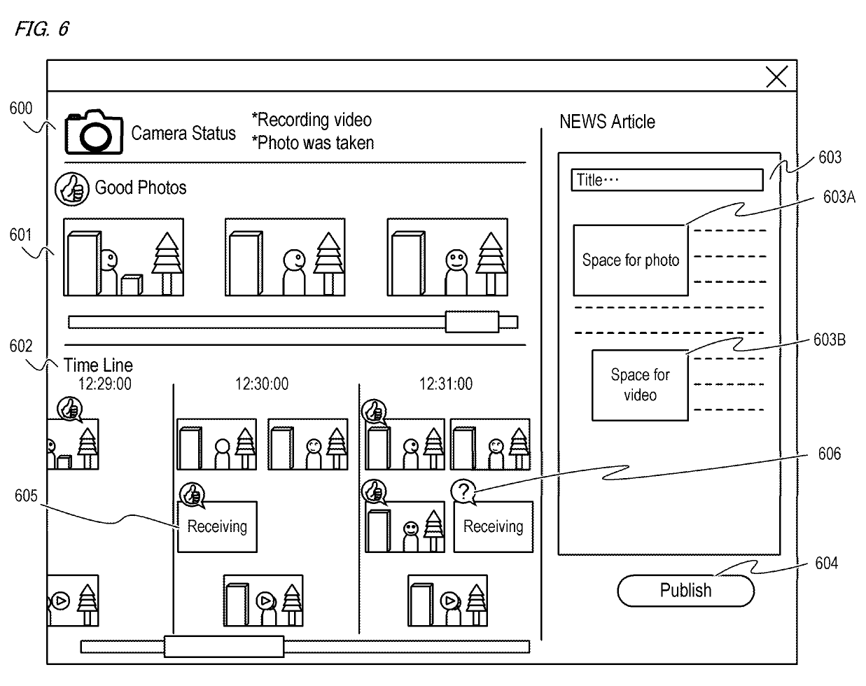

FIG. 6 illustrates an example of display of a screen of an editing application that operates on the PC 400 according to the second embodiment. In the same manner as in the first embodiment, the editing application displays the moving image and still images received from the server 300 (camera 100), and the still images and moving image to be used for a new article can be selected. By using the editing application, the user can edit the text in the news article and publish the news article containing the selected still images and moving image.

In the second embodiment, in the timeline area 602 (area for displaying the moving image and still images received from the server 300 on the timeline), a still-image reception status icon 605 is displayed at the time point when the still image has not been received successfully from the server 300. The still-image reception status icon 605 is a display item indicating that a still image will be transmitted in the future. At this time, in the same manner as in the first embodiment, as long as a still image to be transmitted in the future satisfies the predetermined condition, the PC 400 also displays the Good icon. Then, when receiving a still image, the PC 400 replaces the still-image reception status icon 605 with the received still image.

At a time point when the state determination result has not been received from the server 300, the PC 400 displays a state-determination-result reception status icon 606 together with the still image (or the still-image reception status icon 605). The reception status icon 606 is a display item indicating that the status determination result has not been received successfully (it is unknown whether or not the still image satisfies the predetermined condition). When receiving the state determination result, the PC 400 stops displaying the state-determination-result reception status icon 606.

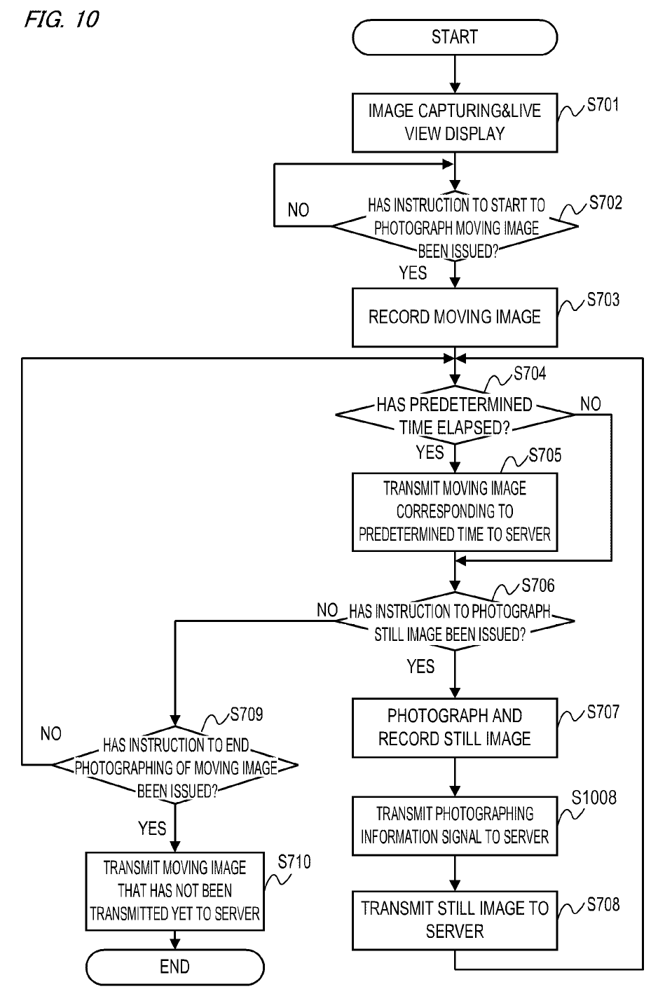

Referring to the flow chart of FIG. 10, a description will be given of the operation of the camera 100 according to the second embodiment. In the second embodiment, in addition to the flow chart of FIG. 7, the processing in Step S1008 is performed. As shown in FIG. 10, Step S1008 is performed between Step S707 and Step S708.

In Step S1008, the system control unit 50 transmits, to the server 300, a photographing information signal indicating information such as a file name and a photographing date and time of the still image (still image photographed in Step S707). In other words, the photographing information signal is transmitted to the server 300 before the still image is transmitted.

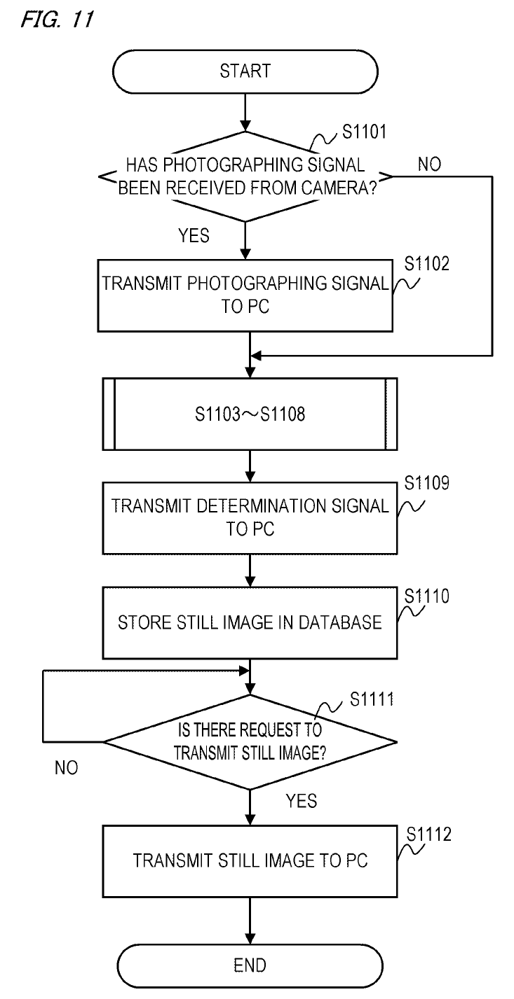

Referring to the flow chart of FIG. 11, a description will be given of the operation of the server 300 according to the second embodiment. The processing in the flow chart of FIG. 11 is started when the photographing information signal or the image (moving image or still image) from the camera 100 is received by the server 300.

In Step S1101, the control unit 301 determines whether or not the photographing information signal has been received from the camera 100. When it is determined that the photographing information signal has been received, the flow proceeds to Step S1102. When it is determined that the photographing information signal has not been received, the flow proceeds to Step S1103.

In Step S1102, the control unit 301 transmits the received photographing information signal to the PC 400.

Steps S1103 to S1108 are the same as Steps S801 to S806.

In Step S1109, the control unit 301 generates a determination signal indicating the file name and the state determination result of the still image, and transmits the determination signal to the PC 400.

In Step S1110, the control unit 301 stores the received still image in the database of the recording medium 304.

In Step S1111, the control unit 301 determines whether or not there is a request to transmit a still image from the PC 400. When it is determined that the request to transmit a still image has been issued, the flow proceeds to Step S1112. When it is determined that the request to transmit a still image has not been issued, the processing in Step S1111 is repeated.

In Step S1112, the control unit 301 transmits a still image that has not been transmitted yet to the PC 400.

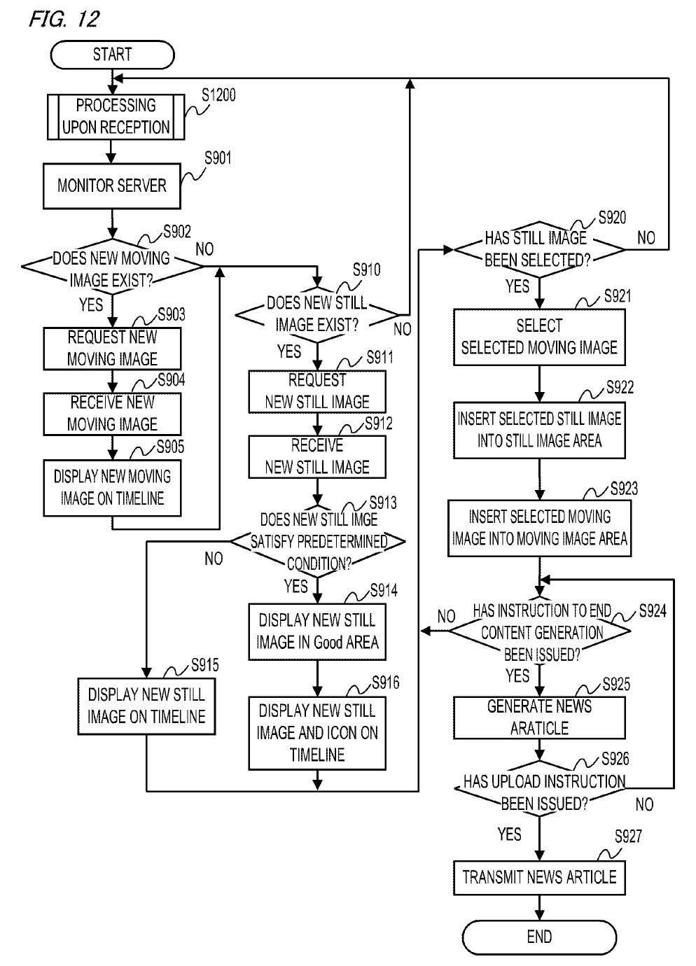

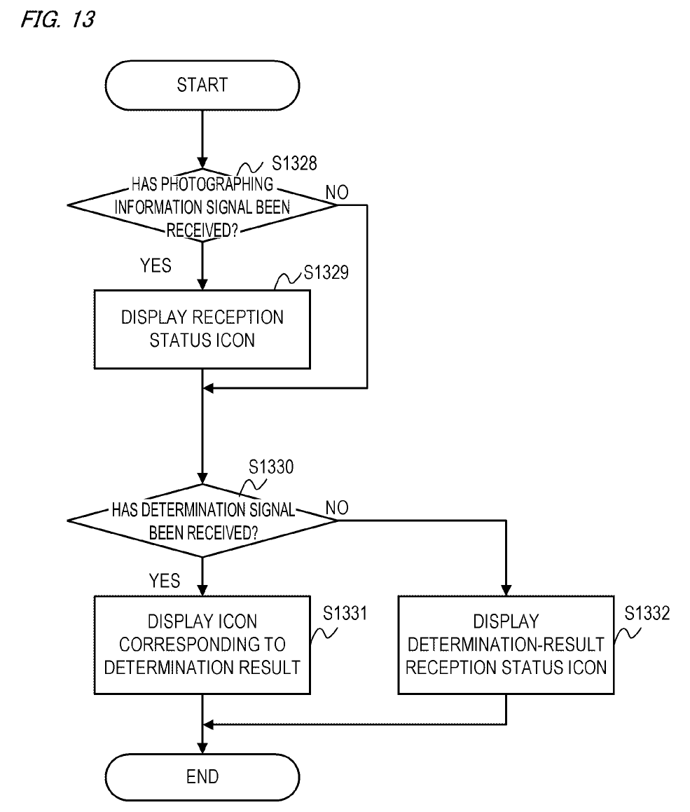

Referring to the flow chart of FIG. 12, a description will be given of the operation of the PC 400 according to the second embodiment. Here, in the second embodiment, in addition to the flow chart of FIG. 9, the processing in Step S1200 (Steps S1328 to 1232 in FIG. 13) is executed. Note that, in Step S912, the determination signal has been already received, and therefore the control unit 401 receives only a new still image. In Step S913, the control unit 401 determines whether or not the new still image satisfies the predetermined condition on the basis of the determination signal.

In Step S1200, the control unit 401 executes processing in accordance with the reception of the photographing signal and the determination signal. Referring to the flow chat of FIG. 13, details of processing in Step S1200 will be described.

In Step S1328, the control unit 401 determines whether or not the photographing information signal has been received from the server 300. When it is determined that the photographing information signal has been received, the flow proceeds to Step S1329. When it is determined that the photographing information signal has not been received, the flow proceeds to Step S1330.

In Step S1329, the control unit 401 displays the still-image reception status icon 605 in the timeline area 602 shown in FIG. 6. At this time, the control unit 401 references the photographing time blocks of the already received moving images to determine the photographing time block of the moving image that includes the photographing date and time recorded in the photographing information signal. Then, the control unit 401 displays the still-image reception status icon 605 at a position where the still image is to be arranged in the determined photographing time block. Here, the control unit 401 calculates the photographing time block of the moving image on the basis of a photographing start time and a photographing end time (or the photographing start time and a playback time of the moving image). Note that, when the reception of the still image is completed, the control unit 401 replaces the still-image reception status icon 605 with the still image.

In Step S1330, the control unit 401 determines whether or not the determination signal has been received from the server 300. When it is determined that the determination signal has been received, the flow proceeds to Step S1331. When it is determined that the determination signal has not been received, the flow proceeds to Step S1332.

In Step S1331, the control unit 401 displays, on the basis of the file name recorded in the determination signal, an icon corresponding to the state determination result of the still image. At this time, the control unit 401 superimposes the icon corresponding to the state determination result of the still image on the thumbnail of the still image or on the still-image reception status icon 605. The icon corresponding to the state determination result is the Good icon when the still image corresponding to the state determination result satisfies the predetermined condition.

In Step S1332, the control unit 401 displays the state-determination-result reception status icon 606 so that the state-determination-result reception status icon 606 is superimposed on the thumbnail of the still image or on the still-image reception status icon 605. Note that, when receiving the determination signal, the control unit 401 stops displaying the state-determination-result reception status icon 606 or replaces the state-determination-result reception status icon 606 with the Good icon corresponding to the state determination result or the like.

Note that, when the still-image reception status icon 605 is displayed in Step S1329, then, in Steps S915 and S916, the still-image reception status icon 605 is replaced with the thumbnail of the still image. When the state-determination-result reception status icon 606 is displayed in Step S1332, then, in Step S916, the state-determination-result reception status icon 606 is replaced with an icon corresponding to the state determination result.

According to the second embodiment, the PC 400 displays the still-image reception status and the state-determination-result reception status in accordance with the received photographing information signal and determination signal. As a result, even when, e.g., there is a delay in the transmission of the still image or in the processing in the server 300, the user is allowed to know that the still image satisfying the predetermined condition will be transmitted to the PC 400 in the future.

### Third Embodiment

The third embodiment will describe an example in which still image and moving image editing processing is added to the PC 400 with respect to the first embodiment, as in the following (1) to (9). Note that, in the third embodiment, a descriptions of the same components and processing as those in the first embodiment is omitted as appropriate.

(1) The PC 400 is capable of acquiring accompanying information recorded on images (still and moving images). Specifically, the PC 400 can acquire the accompanying information from the images (still and moving images) recorded on the recording medium 404. The accompanying information includes the photographing information (information such as the shutter speed or aperture during photographing), attitude information of the camera 100 during the photographing, auto-focus information (information such as focus coordinates), information such as the date and time of the photographing, and the like. As the accompanying information of the moving image, information for each frame is also recorded. Note that, while the example in which the accompanying information is recorded on the images (still and moving images) is shown, the accompanying information may also be recorded in another file associated with the images.

(2) The PC 400 can specify a cut-out range for the still image. Specifically, the PC 400 can specify the cut-out range for the still image in response to a user operation on the operation unit 405. In the third embodiment, the user specifies a rectangular area including a subject area as the cut-out range for the still image. However, it may also be possible that, when the user specifies a subject (position of the subject), the PC 400 specifies a rectangle including the specified subject area. The aspect ratio of the rectangle in the cut-out range is not particularly limited.

(3) The PC 400 can detect an area of the still image that includes the subject. Specifically, the PC 400 detects the subject from the still image, and detects the area including the subject (subject area). A method of detecting the subject is not particularly limited, and a known method may also be used.

(4) The PC 400 is capable of determining the cut-out range for the still image (area of the still image where cutting out is to be performed). Specifically, the PC 400 determines the cut-out range on the basis of the accompanying information, information on the specified cut-out range, information on the subject area, or the like.

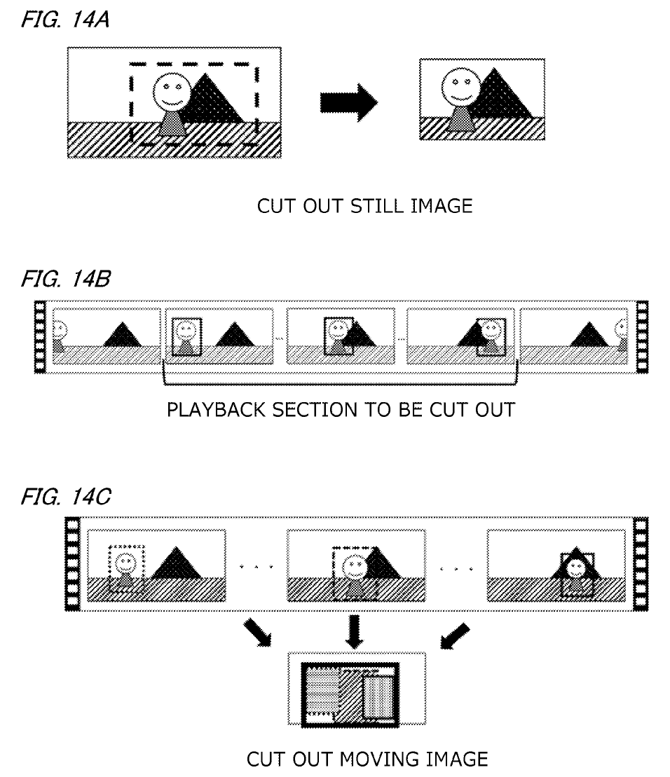

(5) The PC 400 can cut out a partial area of the still image. Specifically, as shown in FIG. 14A, the PC 400 generates a new still image by cutting out a partial range from the still image.

(6) The PC 400 is capable of determining a frame of a moving image corresponding to the still image (hereinafter referred to as the "corresponding frame"). Specifically, the PC 400 determines, as the corresponding frame, a frame in the moving image generated during the time block corresponding to that of the still image in which the same scene as that of the still image is seen. In the third embodiment, the PC 400 acquires the photographing dates and times of the still image and the moving image from the accompanying information of the still image and the moving image, and determines, among all the frames in the moving image, the frame having the photographing date and time closest to that of the still image as the corresponding frame. As a method of determining the corresponding frame, any method may be used, such as "a method of comparing the degree of matching between two images" or "a method of determining the corresponding frame on the basis of a correspondence relationship between identifiers (GUIDs) recorded in the accompanying information of the moving and still images during photographing".

(7) The PC 400 is capable of acquiring information (referred to as the "range determination information") used to determine the cut-out range for the still image. The PC 400 acquires the range determination information, and also acquires a reason for determining the cut-out range at the same time.

(8) The PC 400 can cut out a portion of a playback section of the moving image. Specifically, the PC 400 generates a new moving image by cutting out the range of the portion of the playback section from the moving image. The playback section to be cut out is determined on the basis of the range determination information so as to include the corresponding frame (frame corresponding to the still image). In the third embodiment, as shown in, e.g, FIG. 14B, the PC 400 determines a playback section in which a subject of interest when the still image area was cut out appears as the playback section to be cut out. In addition, the PC 400 may also change the length of the playback section to be cut out depending on the posting destination of the moving image (such as SNS or news article). When the playback section to be cut out does not reach a specific time with one moving image, the PC 400 may also cut out portions of playback sections from a plurality of moving images including the selected moving image and having consecutive photographing times, and combine the cut-out playback sections together.

(9) The PC 400 can cut out the range of a portion of the image in each frame of the moving image. Specifically, after determining the "a cut-out range for the moving image", the PC 400 cuts out the cut-out range from the image in each frame and handles the cut-out range of each frame as an image in each frame of a new moving image. This allows the PC 400 to generate the new moving image. In the third embodiment, as shown in FIG. 14C, the PC 400 determines the cut-out range in each frame in the same manner as for the still image. Then, the PC 400 calculates a range (range enclosed by the thickest line frame in FIG. 14C) including all the cut-out ranges determined for the individual frames, and sets the calculated range as a "moving image cut-out range" (range to be cut out from each frame). In other words, the range in which the specific subject is seen in the image in each of all the frames (each frame) is determined.

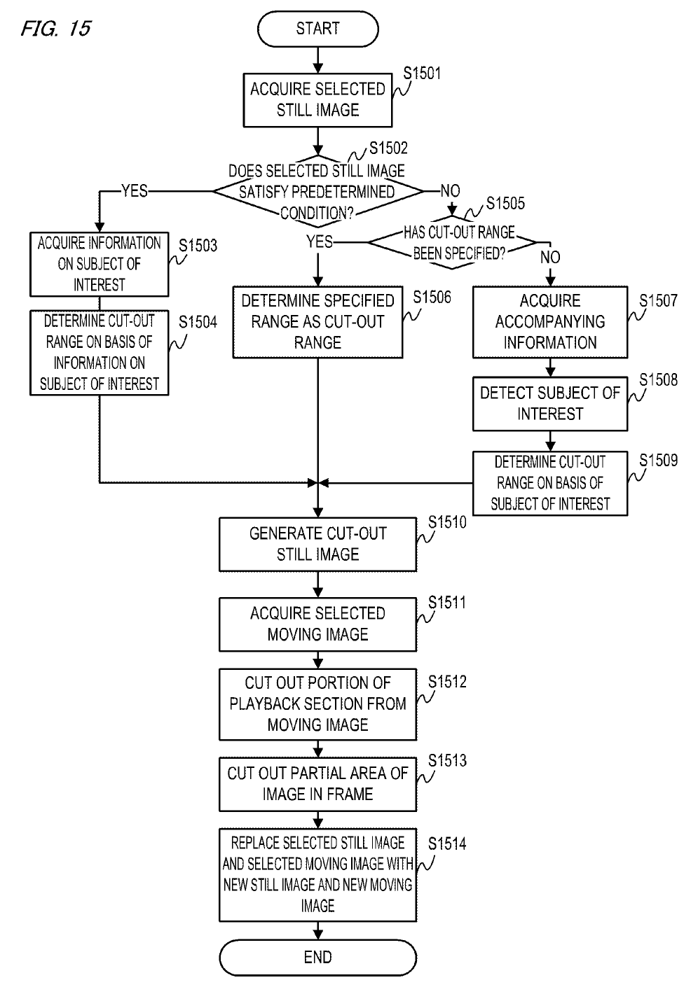

Referring to the flow chart of FIG. 15, the operation of the PC 400 according to the third embodiment will be described. The processing in the flow chart of FIG. 15 is executed between Steps S921 and S922 in the flow chart of FIG. 9 according to the first embodiment. The processing in the flow chart of FIG. 9 (processing in Steps S901 to S927) is otherwise executed in the same manner as in the first embodiment.

Note that, in Step S912, the control unit 401 receives not only the still image and the state determination result, but also information on a subject-of-interest area when the state of the still image is determined as "information used to determine the state of the still image". The subject-of-interest area is, for example, an area of a subject for which it is determined whether or not the subject has closed eyes, whether or not the subject is in focus, or the like. For example, the subject-of-interest area is the area of a specific person. In the third embodiment, the description will be given by using "information on the subject-of-interest area" as an example of the "information used to determine the state of the still image". However, the "information used to determine the state of the still image" may also be coordinates used to determine the state of the still image, face information used to determine the state of the still image, or the like.

In Step S1501, the control unit 401 acquires the still image (selected still image) selected in Step S920.

In Step S1502, the control unit 401 determines whether or not the selected still image satisfies the predetermined condition. When it is determined that the selected still image satisfies the predetermined condition, the flow proceeds to Step S1503. When it is determined that the selected still image does not satisfy the predetermined condition, the flow proceeds to Step S1505.

In Step S1503, the control unit 401 acquires information on the subject-of-interest area when the state of the selected still image was determined.

In Step S1504, the control unit 401 specifies a range including the subject of interest in the selected still image on the basis of the information on the subject-of-interest area acquired in Step S1503. The control unit 401 determines the specified range as the "cut-out range" for the selected still image.

In Step S1505, the control unit 401 determines whether or not the cut-out range for the selected still image has been specified by the user. When it is determined that the cut-out range for the selected still image has been specified by the user, the flow proceeds to Step S1506. When it is determined that the cut-out range for the selected still image has not been specified by the user, the flow proceeds to Step S1507.

In Step S1506, the control unit 401 determines the range specified by the user (range in the selected still image) as the "cut-out range" for the selected still image.

In Step S1507, the control unit 401 acquires accompanying information of the selected still image.

In Step S1508, the control unit 401 detects one or more subjects in the selected still image. Then, the control unit 401 detects a subject closest to focus coordinates included in the accompanying information as the subject of interest.

In Step S1509, the control unit 401 specifies the range including the subject of interest on the basis of the subject of interest detected in Step S1508. The control unit 401 determines the specified range as the "cut-out range" for the selected still image.

In Step S1510, the control unit 401 cuts out the determined cut-out range from the selected still image to generate a new still image. This allows the control unit 401 to obtain the new still image (hereinafter referred to as the "cut-out still image") from which an extra region has been removed and which is appropriate for a news article.

In Step S1511, the control unit 401 acquires the moving image (selected moving image) selected in Step S921.

In Step S1512, the control unit 401 cuts out a moving image of a portion of the playback section in the selected moving image on the basis of the information used to determine the cut-out range for the selected still image. Thus, the control unit 401 generates the new moving image.

In Step S1513, the control unit 401 determines a "moving image cut-out range" for the moving image generated in Step S1512. The control unit 401 newly generates the moving image (hereinafter referred to as the "cut-out moving image") by cutting out the "moving image cut-out range" from the image in each frame of the moving image generated in Step S1512. Here, the cut-out moving image is generated such that the subject of interest appears in the image in each frame of the cut-out moving image. Thus, it is possible to obtain the new moving image from which an extra playback section and an extra area have been removed and which is appropriate for a news article. Note that the "moving image cut-out range" can also be determined on the basis of information used to determine the cut-out range for the selected still image (information on the range specified by the user, information on the subject of interest, or the accompanying information of the selected still image).

In Step S1514, the control unit 401 replaces the selected still image and the selected moving image that were selected in Steps S920 and S921 with the cut-out still image and the cut-out moving image that were newly generated in Steps S1510 and S1513. In other words, the control unit 401 performs control so as to use the cut-out still image and the cut-out moving image in the processing in Steps S922 and S923.

According to the third embodiment, unnecessary information can be removed from the selected still image and the selected moving image, and therefore it is possible to easily generate a still image and a moving image that are appropriate for a news article. In other words, it is possible to generate a more preferable news article, while reducing the effort of the user.

In addition, in the above description, "the flow proceeds to Step S1 when A is not less than B, and proceeds to Step S2 when A is smaller (lower) than B" may also be read as "the flow proceeds to Step S1 when A is larger (higher) than B, and proceeds to Step S2 when A is not more than B". Conversely, "the flow proceeds to Step S1 when A is larger (higher) than B, and proceeds to Step S2 when A is not more than B" may also be read as "the flow proceeds to Step S1 when A is not less than B, and proceeds to S2 when A is smaller (lower) than B". Therefore, unless contradiction arises, "not less than A" may also be read as "larger (higher, longer, or more) than A", and "not more than A" may also be read as "smaller (lower, shorter, or less) than A". Furthermore, "larger (higher, longer, or more) than A" may also be read as "not less than A", and "smaller (lower, shorter, or less) than A" may also be read as "not more than A".

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to reduce the load of the operation of sorting out an image from among a plurality of moving images and a plurality of still images.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electronic apparatus for controlling display of a specific screen displayed on a display, the electronic apparatus comprising:
a processor; and
a memory storing a program which, when executed by the processor, causes the moving-image file generation device to
acquire a plurality of moving images respectively photographed during a plurality of continuous time blocks and a plurality of still images photographed during photographing of the plurality of moving images; and
execute control processing that 1) chronologically displays the plurality of moving images in a first area of the specific screen and 2) displays, for each time block during which the one or more still images are photographed among the plurality of time blocks, a moving image photographed during the time block and the one or more still images photographed during the time block in association with each other in the first area.

2. The electronic apparatus according to claim 1,
wherein the program, when executed by the processor, further causes the electronic apparatus to
select a first moving image photographed during the time block during which a first still image corresponding to the selected still image is photographed, when one still image is selected from among the plurality of still images.

3. The electronic apparatus according to claim 2,
wherein the specific screen has a second area where a moving image and a still image that are related to each other are arranged, and
wherein in the control processing the first still image and the first moving image selected are arranged in the second area, in a case where the first still image is selected.

4. The electronic apparatus according to claim 3,
wherein in the control processing a first range obtained by cutting out a portion of the first still image is arranged in the second area, when the first still image is selected.

5. The electronic apparatus according to claim 4,
wherein in the control processing the first range is determined on a basis of specification by a user, information on a specific object in the first still image, or accompanying information of the first still image.

6. The electronic apparatus according to claim 3,
wherein in the control processing a second moving image obtained by cutting out at least either of a range of a partial playback section of the first moving image and a range of a part of an image of each frame of the first moving image is arranged in the second area, when the first still image is selected.

7. The electronic apparatus according to claim 6,
wherein in the control processing the range of the partial playback section of the first moving image is determined on a basis of the specification by a user, information on a specific object in the first still image, or accompanying information of the first still image.

8. The electronic apparatus according to claim 6,
wherein in the control processing the range of the part of the image of each frame of the first moving image is cut out such that a specific object appears in an image in each frame of the second moving image.

9. The electronic apparatus according to claim 5,
wherein the accompanying information includes, as information during photographing, at least any of shutter speed information, aperture information, image capturing device attitude information, autofocus information, and photographing date and time information.

10. The electronic apparatus according to claim 3,
wherein, in the second area, a content including a moving image and a still image that are related to each other and including a text is arranged,
wherein the program, when executed by the processor, further causes the electronic apparatus to output the content.

11. The electronic apparatus according to claim 1,
wherein the plurality of still images transmitted from an external device are acquired, and
wherein in the control processing at a time point when any of the plurality of still images has not been acquired, a first display item indicating that the still image is to be transmitted instead of a still image that has not been acquired is displayed in the first area.

12. The electronic apparatus according to claim 11,
wherein in the control processing when acquiring a still image corresponding to the first display item displayed in the first area, the first display item displayed in the first area is replaced with the still image.

13. The electronic apparatus according to claim 1,
wherein, in a case where a still image satisfying a predetermined condition is displayed in the first area, in the control processing a second display item indicating that the still image satisfies the predetermined condition is displayed.

14. The electronic apparatus according to claim 13,
wherein the specific screen has a third area different from the first area, and
wherein in the control processing the one or more still images satisfying the predetermined condition that are among the plurality of still images are arranged and displayed in the third area.

15. The electronic apparatus according to claim 13,
wherein information on a determination result indicating whether or not each of the plurality of still images satisfies the predetermined condition is acquired, and
wherein in the control processing at a time point when the information on the determination result for any of the plurality of still images has not been acquired by the acquisition means, a third display item indicating that the determination result has not been acquired is displayed at a position in the first area that corresponds to the still image for which the determination result has not been acquired.

16. The electronic apparatus according to claim 15,
wherein, in a case where the information on the determination result corresponding to the third display item displayed in the first area is acquired, the control means switches the third display item displayed in the first area to display corresponding to the determination result.

17. The electronic apparatus according to claim 13,
wherein the predetermined condition is a condition that a specific composition is provided, a condition that the specific object is not closing his or her eyes, or a condition that the specific object is in focus.

18. A control method of an electronic apparatus for controlling display of a specific screen displayed on a display, the method comprising:
acquiring a plurality of moving images respectively photographed during a plurality of continuous time blocks and a plurality of still images photographed during photographing of the plurality of moving images; and
executing control processing that 1) chronologically displays the plurality of moving images in a first area of the specific screen and 2) displays, for each time block during which the one or more still images are photographed among the plurality of time blocks, a moving image photographed during the time block and the one or more still images photographed during the time block in association with each other in the first area.

19. A non-transitory computer readable medium that stores a program, wherein the program causes a computer to execute a control method comprising:
acquiring a plurality of moving images respectively photographed during a plurality of continuous time blocks and a plurality of still images photographed during photographing of the plurality of moving images; and
executing control processing that 1) chronologically displays the plurality of moving images in a first area of the specific screen and 2) displays, for each time block during which the one or more still images were photographed among the plurality of time blocks, the moving image photographed during the time block and the one or more still images photographed during the time block in association with each other in the first area.
